(19) United States
(12) Patent Application Publication
(10) Pub. No.: US 2010/0178149 A1
(43) Pub. Date: Jul. 15, 2010

(54) PROCESS AND DEVICE FOR MULTI-LAYER STACKING ON A SUPPORT

(75) Inventor: Roland Fritzsche, Nurnberg (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DEMATIC GMBH & CO. KG, Offenbach (DE)

(21) Appl. No.: 12/294,495

(22) PCT Filed: Mar. 13, 2008
(86) PCT No.: PCT/EP2008/053008

§ 371 Date: Mar. 29, 2010

(30) Foreign Application Priority Data
Apr. 7, 2007 (DE) 10 2007 016 727.1

(51) Int. Cl. B65G 57/22; B65G 57/02; B65G 61/00; B65B 11/02

(52) U.S. Cl. 414/789.5; 414/802; 414/789.6; 53/580

(57) ABSTRACT

An automatic device and method for multi-layer stacking on a support with objects to be stacked in a predetermined spatial arrangement includes a control for determining a particular order and particular spatial positions of the objects to be stacked on the support, at least two conveying systems operable to transport the objects in the particular order, and at least two handling devices that take respective objects from a respective conveying system and displace the respective objects to the articular spatial positions, thereby forming a stack of the objects on the support.

The invention relates to an automatic process for multi-layer stacking of a support, in particular a pallet, with objects to be packed having different dimensions, in a predetermined spatial arrangement, and a corresponding device.

The automatic stacking of a support, in particular a pallet or a rolling truck, with objects to be packed in order to form a stack, i.e. palletisation, is known per se. However, in this case objects to be packed which have uniform size or dimensions are by laid down by robots, gripping devices etc at computationally-determined locations.

In contrast, the process of automatically loading a load support with objects to be packed which have different dimensions in order to form a stack is a matter of so-called automatic “mixed-case” palletising.

In that case, different aspects must be taken into account and these enormously increase the complexity compared with “simple” stacking. A subsequent object to be packed can therefore only be stacked or placed on a previous object in a satisfactory manner if this previous object has a flat or even surface which should also be oriented approximately horizontally, and if the object can bear the weight of the further objects placed on it without being damaged.

Furthermore, the stack formed should have a certain stability so that, amongst other things, it does not fall over during transportation. Wrapping with sheeting does help but cannot by itself stabilise an incorrectly formed stack.

In addition, optimisation of the stack in terms of the desired order of unloading is increasingly desirable for the removal of objects from the stack.

The stacking of different objects to be packed or items with different sizes or dimensions is thus usually effected manually since the requirements of stability of the stack, packing density within the stack as well as the order of loading and unloading thereby dictated and, not least, the stackability of the items are extremely high and have not thus far been fulfilled or only partially fulfilled by the known processes and devices.

From EP 1 462 394 B1 e.g. a device is known for automatic loading of a load support with units to be packed forming a load stack, i.e. a palletising device. With this device the units to be packed are supplied lying on trays and from these trays are laid onto a packing table. At that point a pushing device displaces the unit to be packed lying on the table along the broad side of the pallet to be loaded until the loading coordinates in the X direction are achieved. Then a further pushing device and a loading tongue displace the unit to be packed in the direction of the loading depth over the pallet until the loading coordinates in the Z direction are achieved. Then the loading tongue moves back, wherein the pushing device remains stationary and serves as a stripping device so that the unit to be packed on the pallet is laid down in a “free fall” manner at the desired location. The stack being formed is thus supported by a loading aid on the remaining three sides. It is thus stacked more or less “against the wall”.

The pallet or a rolling truck are accessible from only one side. In addition, the pallet must be adjusted in height after each loading process in order to load the next free space when the pallet is being loaded in the so-called “mixed-case” process, i.e. with different units to be packed. The displacement on the packing table is time-consuming. In addition, by reason of the construction of the device, the exchanging of the pallets or rolling trucks involves long waiting times. This further reduces the total achievable performance or throughput per hour.

From DE 43 38 801 A1 a process is known for stacking piece items of different sizes and/or quality, which are supplied in any alternating sequence, wherein the size and/or quality of the piece items are registered and these are provided in order to be grasped—with the size and/or quality known in each case—at a specific site within the grasping area of a handling mechanism which carries out the stacking, in order thereafter to be engaged by the handling mechanism in a sequence controlled in dependence upon the availability of the piece items in or for the grasping area of the handling mechanism and upon the momentary state of the stack to be formed, and in order to be set down at a specific location in the stack. Upstream of the grasping area the piece items are distributed according to size and/or quality separately to a number of buffers from which they are removed selectively according to the momentary state of the stack and the availability in the buffers.

DE 41 14 215 A1 describes a device for loading pallets with square objects by means of a palletising device with an articulated arm which can move up and down and can pivot and on the end of which a suction head or the like is disposed, wherein the boxes can be supplied to the palletising device on at least one supply conveyor, wherein the palletising device has two articulated arms which can be moved independently of each other.

From DE 39 06 922 A1 a device for creating a unit of a stack of objects with stacking elements is known in order to stack a plurality of objects on a surface on a turntable or on the surface thereof. While the objects are being stacked on the selected surface a wrapping film or sheeting is wound on the stack at intervals depending on the stacking operation or after the stacking operation is complete. For this purpose a device for supplying a wrapping material to the turntable and a cutting device for severing the wrapping material are provided.

In contrast, the object of the present invention is to provide a process and a device for automatic multi-layer stacking of a support with objects to be packed which have different dimensions in a predetermined spatial arrangement, which process and device permit mixed-case stacking in a flexible manner and with a high throughput.

This object is achieved by the process depicted in claim 1 and by the device stated in claim 15. Advantageous embodiments are given by the subordinate claims and the description.

By reason of the fact that the objects to be packed are brought in by means of at least two independent conveyors and that the handling means are present at least in duplicate in order for the objects to be packed to be transferred from a respective conveyor in an alternating manner and to be displaced, wherein each handling means is allocated to a conveyor, it is possible to stack the support in a flexible manner and with a high level of performance. In particular, a broad spectrum of different objects to be packed can be stacked in a continuous manner. In addition to objects which are naturally also manageable, uniform and unproblematic, objects to be packed which have very different dimensions can also be stacked onto the support one after the other.

Objects to be packed can be widely different items, packaged items, items packaged in groups, such as cartons, crates, boxes, containers, items on trays and also unpackaged items of all types, etc.

Apart from pallets the supports may also be roller trucks or similar substructures for piece items and their packaging.

Conveying systems are to be understood to include conveyors in general and in particular roller conveyors, conveyor belts and conveyor installations. These can be loaded manually or automatically. The objects to be packed are supplied individually and in the correct order for the desired packing sequence on the conveying system. The correct order etc is determined computationally when processing a contract. Appropriate software for this purpose is known.

The objects to be packed are thus supplied individually. For handling purposes the objects can be gripped and handled individually. However, it is also possible to group together groups of identical or very similar packaged or unpackaged objects for common handling. This grouping is then effected in the area where the objects to be packed are transferred from the conveying system by the handling means.

It is particularly advantageous if the handling means can displace the objects to be packed in at least two, preferably three, spatial directions when placing them on the stack being formed on the support. This permits a large degree of freedom in positioning the objects to be packed, which is important in achieving good use of space during stacking and in implementing the computed requirements in the most precise manner possible. Therefore in particular objects can also be loaded for which known systems are not provided.

It is also useful if the objects to be packed are oriented before being taken by the handling means. This permits the objects to be taken by the handling means in a standardised manner. Alternatively or additionally, appropriate optical processes can also be used to recognise the orientation of the objects to be packed and to control the handling means.

However, it is also possible to use the handling means themselves in the case of a corresponding arrangement for orienting the objects to be packed. This could be effected either in a separate step or even in the step of transfer from the conveying system to the support.

It is useful if the stack on the support is stabilised during and/or after stacking. The individual layers therefore retain their structure and the stacked support can be transported safely. For this purpose the stack can be stabilised together with the stacked support by wrapping with sheeting, netting or the like, as known to the person skilled in the art.

Stabilisation, e.g. wrapping, can be effected either in layers progressively during stacking or after the stacking of a layer. In the case of this variation stabilisation can take place within the actual stacking device e.g. by layer-wise lowering and wrapping of the partially stacked support. This saves time.

Alternatively, after the end of the stacking process the stabilisation as a whole can then take place, for which purpose stabilisation is then spatially separate from the stacking process.

According to the invention the device for automatic multi-layered stacking of a support, in particular a pallet, with objects to be packed having different dimensions is characterised in that at least two independent conveyors are provided in order to bring in the objects, and that the handling means for alternating transfer of objects from a respective conveyor and for displacement are provided at least in duplicate, wherein each handling means is allocated to a conveyor.

It is also particularly preferred in this case if the handling means are formed in order to displace the objects to be packed in at least two, preferably three, spatial directions when being placed onto the stack being formed on the support. For this purpose the handling means can include at least one automatic multi-axle gripping system. Particularly preferred is the use of two multi-axle gripping systems with working areas which overlap. Therefore objects to be packed can be removed and stacked from the conveyors or conveying system in an alternating manner. With appropriate control the supports can therefore be stacked in parallel on two sites.

In particular multi-axle gripping systems with at least two degrees of freedom of movement are suitable. The multi-axle gripping systems can comprise e.g. two mutually independent travel units on a common linear axis in a direction (X) having gripping means for the objects to be packed which move in two other directions (Y and Z).

The object gripping means can in each case additionally comprise at least one degree of freedom of rotational movement, i.e. can be rotated and also tilted when two rotational axes are provided.

In particular gantry robots or articulated arm robots and especially double gantry robots or double articulated arm robots are suitable as handling means. Most preferred, as already stated, is the use of two multi-axle gripping systems so that double gantries should be used which have two mutually overlapping working areas.

The handling means can thus comprise automatic multi-axle gripping systems, which share a common horizontal displacement path. This permits overlapping working areas to be formed easily.

The object gripping means can include lifting forks, cams, gripping devices, suction devices or clamping gripping devices and combinations thereof to grip the individual objects to be packed. In particular object gripping means are suitable which grip the objects in a clamping manner, especially from below in a supporting manner and from above in a pressing manner. This permits secure transfer from the conveying system at high speed without the objects slipping, shifting or falling. In this way the clamping can be effected from above via a correspondingly moveable plunger. This can be provided for protective handling of the objects with a gentle yielding contact on the side of the objects to be packed. A foam material contact or an air cushion for example may be used.

The device can additionally comprise a unit for orientation of the individual objects to be packed. This can comprise a lower unit for horizontal displacement and a lower unit for rotation of the individual objects.

A further increase in speed can be achieved if the supports are supplied and discharged in such a way that at the same time as stacked supports are being discharged, empty supports can follow them in. Thus it is feasible for the stacked support to be carried away downwards and to the side, while at the same time a new empty support is brought in at a different height. On the other hand, the potentially heavily laden support can be carried away more slowly without influencing the overall speed of the system.

Depending on the objects to be stacked it may be necessary to place sheets, e.g. of cardboard or card, between, below or above the layers in order to protect them or in order to increase stackability. For this purpose the flat material can be stored and/or supplied in a suitable manner and positioned by suction devices provided on the handling means.

Both the supports (e.g. pallets) and also the sheets (card) can be supplied and provided by means of a separate conveying system. The taking or transfer of the supports or sheets can on the one hand take place with a dedicated system. However, it is also possible to construct and control the handling means, which are already provided in any case, in such a way that these handling means effect the transfer themselves. Pallets could thus be stored e.g. in a stack in the gripping area of the handling means so that the uppermost pallet in the stack can be gripped by the gripping means of the handling means and could be laid on the lifting table. The same is true for the sheets.

In one embodiment provision is made for the support to be surrounded, as it is being loaded with the objects to be packed, on four sides by a loading aid which is provided in particular with a hopper-like inlet and supports the stack being formed or the respective layer. This permits particularly secure and precise loading with a high level of protection of the surrounding area. This type of loading aid is only possible when the objects to be packed are displaced in at least three spatial directions when being placed on the stack being formed on the support. When seen in cross-section the loading aid is adapted to the dimensions of the support or of the stack in such a way that stacking “against the wall” can take place.

In order to form or stack the next sheet or plane of a stack the handling means can be controlled in such a way that they move towards the corresponding Z coordinates. For this purpose the device is then naturally to be formed in such a way that sufficient space is available for the stack being formed.

Alternatively or additionally, the device can be formed with a unit for lowering/raising the support. In addition to the lowering action after the stacking of a sheet this also permits level adjustment during stacking. This leads to a considerable increase in performance since relatively long paths for placement of the objects to be packed in the means are avoided and/or the vertical travel times can be traveled during the positioning process in the X and Z direction.

In order to stabilise the support a stabilising unit can be provided such as a sheeting wrapping device (see above). This unit can be integrated directly into the device such as e.g. a palletising machine. This has the advantage that the support with the formed stack does not have to be moved separately. Thus stabilisation can be effected e.g. each time a sheet or layer is lowered. This means that even in the case of supports which are actually stacked in an unstable manner a large degree of stability in the stack can be achieved. This also considerably expands the possibilities for stack formation with respect to the items and the selectable order.

Of course, as an alternative to the sheeting wrapping technique all other known possibilities for stabilisation can be used. These include e.g. shrink wrapping, netting and other expandable materials, hook and loop connections and adhesive connections etc.

When stacking supports the order of the objects to be packed, their two- and three-dimensional arrangement and their destination, are of prime importance. In principle optimal stacking is possible only when the content of the stack is precisely known in advance. Severe problems arise when there must be some deviation therefrom such as in the event of short-notice changes (just in time) to customer contracts etc. Thus e.g. a particularly heavy object cannot be laid or stacked on fragile objects. This problems can be mitigated within the scope of the present system when buffer places for objects to be packed are provided in the operating area of the handling means. This makes possible intermediate storage of objects when the actually desired and predetermined order of the stacking cannot be maintained. Restacking is also possible to a limited extent without the objects to be packed having to be spatially completely transported away or having to switch to manual operation.

Further advantages, properties and features of the invention are given by the following description of an exemplified embodiment with the aid of the drawing in which

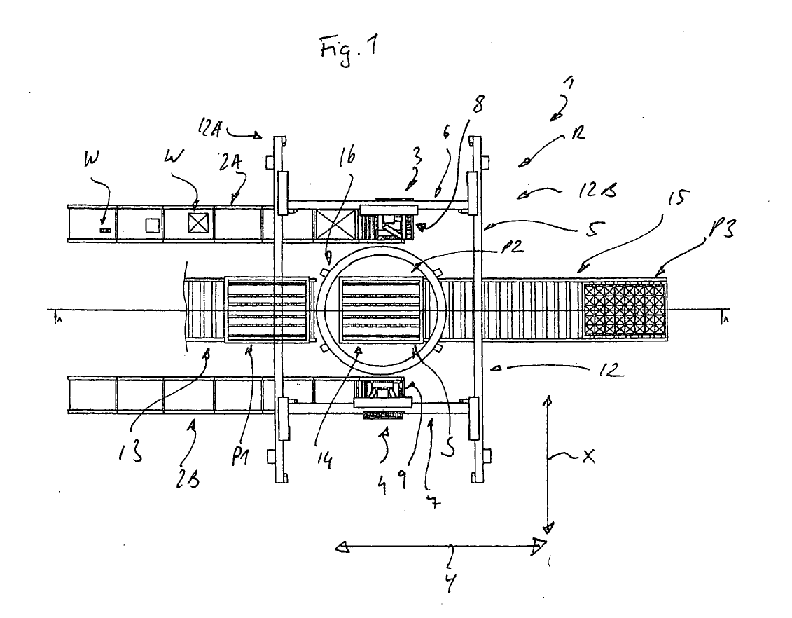

FIG. 1 shows a schematic plan view from above of a device for automatic multi-layer stacking of pallets and

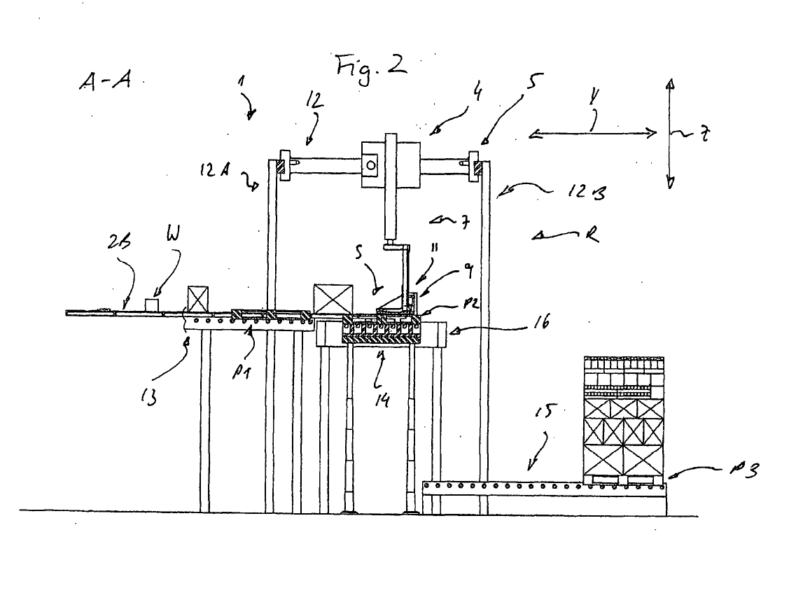

FIG. 2 shows a schematic side view of a cross-section along the line A-A through the device of FIG. 1.

FIGS. 1 and 2 show a device designated as a whole by 1 for automatic multi-layer stacking of pallets P2 with objects W of different dimensions in a predetermined spatial arrangement. This is therefore a device for “mixed-case” palletising. With the device 1 it is naturally also possible to palletise only objects W which are all of one type.

The device 1 includes two independent conveyors 2A, B for supplying the objects to be packed or items W which have been placed separately in the required order. These may be any type of conveyor. Preferably as in the illustrated case belt conveyors are used which merge into roller conveyors at the gripping point. The conveyors 2 are disposed on a higher plane than the floor and spaced apart from each other.

The device 1 also includes two handling means 3,4 which take the unit to be packed W, which is being loaded, from the respective conveyor 2A, B and in an alternating manner lay it down at the desired spatial position on the stack S which is being formed on the pallet P2 currently being worked on.

The handling means 3, 4 are automatic multi-axle gripping systems which comprise at least three degrees of freedom of movement. These comprise two mutually independent travel units 6, 7 on a common horizontal displacement path 5 in a direction X, with object gripping means 8, 9 which are moveable in two other directions Y and Z and each additionally comprise a degree of freedom of rotational movement. The object gripping means 8, 9 can thus move the respective item W in three spatial directions X, Y, Z and at the same time rotate them. Therefore the item W can additionally also be oriented by the handling means 3, 4 during displacement.

They each include both a gripping device 10, 11 which is formed to grip in a clamping manner the objects to be packed, from above in a pressing manner and from below in a supporting manner. For this purpose the gripping devices 10, 11 include a lower fork which, in a known manner, is moved below the item W between the rollers of the conveyor at the gripping point. In addition, the item W is clamped against the fork from above by a corresponding moveable plunger. The item W is therefore securely fixed in the gripping device 10, 11 during high speed displacement.

The handling means in the illustrated example are formed as a gantry robot R, the structure 12 of which is formed in such a way that the conveyors 2A, B each enter its enclosed region at an end face 12A and terminate there. Therefore the delivered items W can each be taken by the associated handling means 3 or 4 and alternately laid onto the pallet P2 or the stack S being formed thereon.

The empty pallets P1 are brought in by a pallet supplier 13 which is disposed between the conveyors 2A, B and approximately in parallel therewith. However, in terms of height it is disposed somewhat below the level of the conveyors 2A, B, which brings advantages during the later stacking procedure (see below). The pallet supplier 13 issues at a pallet lifting table 14 which permits level adjustment as the pallets P2 are being loaded with the objects to be packed.

The fully stacked pallet P3 is carried away by a pallet discharger 15 oriented in line with the pallet supplier 13 and exiting for this purpose from the region of the gantry robot R at the opposite face 12B but being disposed in terms of height on a lower plane than the pallet supplier 13 so that the pallet P2 can be lowered during stacking and, after termination of the stacking procedure, moves in a virtually automatic manner to the height of the pallet discharger 15.

Therefore at the same time a new empty pallet P1 can be moved upwards while the fully stacked pallet P3 is carried away below. In the optimal case the height difference between the pallet discharger 15 and the pallet supplier 13 corresponds to the height of the stack formed so that the lifting table 14 does not have to complete a separate movement in order to discharge the pallet onto the pallet discharger 15.

The exchange of pallets can thus take place almost continually without time-consuming additional transfers etc being necessary.

The illustrated variation also includes a sheeting wrapping unit 16 which is integrated into the device. This is disposed in an annular manner around the lifting table 14 on which the stacking of the pallet P2 is carried out. The sheeting wrapping unit 16 corresponds in structure to known spatially separate sheeting wrapping devices.

After the pallet P2 has been stacked with a layer of items W the pallet P2 is lowered by the average height of the layer by means of the lifting table 14. Therefore the layer comes into the region of the sheeting wrapping unit 16 and can be wrapped in stages at that location in order to make it stable.

The fully stacked pallet is thus already completely wrapped and does not have to be moved to a spatially separate wrapping station. At the same time the integration of the sheeting wrapping unit 16 permits complete stabilisation of the stack being formed, it thereby becomes possible automatically to stack a broader range of items.

The stacking process using the above-described device is described hereinunder.

Firstly the list of items or objects to be packed is composed according to the respective contract and, on the basis of the known dimensions, weight etc thereof, the order and spatial position of the objects in the stack S on the pallet P is determined by computer.

The items are then brought from the stores etc individually in the necessary order by means of, amongst other things, the conveyors 2A, B, wherein the items are delivered in a distributed manner onto the two conveyors 2A, B.

In parallel therewith an empty pallet P1 is disposed on the lifting table 14 by the pallet supplier 13.

The handling means 3, 4 then alternately take the items W from the respective conveyor 2A, B. The conveyor 2A serves the handling means 3 and in a corresponding manner the handling means 4 are supplied with items by the conveyor 2B.

The respective object or item W to be loaded is set down by the corresponding handling means 3 or 4 at the desired spatial position on the stack being formed on the support, for which purpose the objects to be packed are displaced in the usual manner in at least three spatial directions and at the same time—as far as necessary—are rotated.

In order to stack the first layer it is possible to dispose the pallet in such a way that only a displacement of the objects in the horizontal direction, i.e. in the X and Y direction, is required.

After stacking the first layer the pallet is lowered by the lifting table 14 by the average height of the surfaces of the objects so that the next layer can be laid down in the means with displacements being optimised during stacking.

At the same time the wrapping unit, when present, can wrap the layer below the palletising plane for stabilisation purposes. Alternatively, wrapping takes place after the stacking process has completely finished.

The stacking of the next layer is commenced in a parallel manner. The described process is then repeated until the desired stack is complete.

In the ideal case the stacked pallet is now located at the height of the discharger 15 and is transferred thereto from the lifting table 14 and transported away.

At the same time a new empty pallet is supplied from above via the pallet supplier and is held by suitable forks until the lifting table has been moved up from below to contact and support it.

### REFERENCE LIST

1 Device
2 Conveyors
3, 4 Handling means
5 Horizontal displacement path
6, 7 Travel units
8, 9 Gripping means for the objects to be packed
10, 11 Gripping devices
12 Structure
12A, B End face
13 Pallet supplier
14 Lifting table
15 Pallet discharger
16 Sheeting wrapping unit
P1, 2, 3 Pallets
R Gantries
S Stack
W Object to be packed

1. An automatic method for multi-layer stacking on a support with objects to be stacked in a predetermined spatial arrangement, said method comprising:
providing a control for determining a particular order and particular spatial positions of the objects to be stacked on the support;
providing at least two conveying systems operable to transport the objects in the particular order; and
providing at least two handling devices, each taking the objects from one of said conveying systems, said at least two handling devices displacing the respective objects to the particular spatial positions, thereby forming a stack of the objects on the support.

2. The method as claimed in claim 1, wherein said handling devices displace the objects to desired spatial positions in at least two spatial directions.

3. The method as claimed in claim 1, wherein the objects are oriented prior to said handling devices taking the objects.

4. The method as claimed in claim 1, wherein said handling devices orient the objects.

5. The method as claimed in claim 1, comprising stabilizing the support during stacking.

6. The method as claimed in claim 5, wherein the support comprises a stacked support and stabilizing the support comprises wrapping the support with one chosen from sheeting and netting.

7. The method as claimed in claim 5, wherein stacked support is stabilized in layers.

8. The method as claimed in claim 5, wherein stabilizing the support takes place in a stacking device.

9. The method as claimed in claim 5, wherein stabilizing the support is spatially separate from the stacking.

10. The method as claimed in claim 1, wherein said handling devices grip the objects by clamping from below in a supporting manner and clamping from above in a pressing manner.

11. The method as claimed in claim 1, further comprising supplying and discharging supports wherein stacked supports are discharged at substantially the same time as empty supports are supplied, wherein the entering empty supports follow the departing stacked supports.

12. The method as claimed in claim 1, further comprising:
providing sheets;
laying the sheets at a position that is one chosen from i) between layers of objects; ii) above layers of objects; and iii) below layers of objects.

13. The method as claimed in claim 1, further comprising surrounding the support on four sides by a loading aid as the support is being loaded with the objects, wherein said loading aid includes a hopper-like inlet.

14. The method as claimed in claim 1, further comprising adjusting a height of the support as the support is being loaded with the objects.

15. A device for automatic multi-layer stacking on a support with objects in a predetermined spatial arrangement, comprising:
a control operable to determine a particular order and particular spatial positions of the objects to be stacked on the support;
at least two conveying systems, that are adapted to supply the objects separately in the particular order;
at least two handling devices, each operable to take the objects from one of said conveying systems, said at least two handling devices displacing the objects to respective particular spatial positions to form a stack of the objects on the support.

16. The device as claimed in claim 15, wherein said handling devices displace the objects in at least two, spatial directions when the objects are placed onto the stack.

17. The device as claimed in claim 16, wherein said handling devices each include an automatic multi-axle gripping system.

18. The device as claimed in claim 17, wherein each of said multi-axle gripping systems have at least two degrees of freedom of movement.

19. The device as claimed in claim 18, wherein each of said multi-axle gripping systems have two mutually independent travel units on a common linear axis in a first direction, and have object gripping devices for moving the objects in two other directions.

20. The device as claimed in claim 19, wherein said object gripping devices each comprise at least one degree of freedom of rotational movement.

21. The device as claimed in claim 15, wherein said handling devices comprise one chosen from gantries and articulated arm robots.

22. The device as claimed in claim 15, wherein said handling devices comprise at least one chosen from double gantries and double articulated arm robots.

23. The device as claimed in claim 21, wherein said handling devices include automatic multi-axle gripping systems which share a common horizontal displacement path.

24. The device as claimed in claim 19, wherein said object gripping devices include at least one chosen from lifting forks, cams, gripping devices, suction devices and clamping gripping devices to grip the objects.

25. The device as claimed in claim 15, further comprising a unit for orientation of the objects.

26. The device as claimed in claim 25, wherein said unit for orientation of the objects includes a lower unit for horizontal displacement and a lower unit for rotation of the objects.

27. The device as claimed in claim 15, further comprising a unit for lowering and raising the support.

28. The device as claimed in claim 15, further comprising a unit for stabilizing the stack being formed upon the support during stacking.

29. The device as claimed in claim 28, wherein said unit for stabilizing the stack comprises an integrated wrapping unit operable to wrap the support at each layer.

30. The device as claimed in claim 28, further comprising a loading aid with a hopper-like inlet, wherein said loading aid surrounds the support and the stack on four sides during loading with the objects.

31. The device as claimed in claim 15, further comprising a unit for stabilizing the stack on a stacked support after stacking.

32. The device as claimed in claim 31, further comprising a separate wrapping device for wrapping the stack on the stacked support.

33. The device as claimed in claim 19, wherein said object gripping devices include gripping devices operable to grip the objects by clamping from above in a pressing manner and by clamping from below in a supporting manner.

34. The device as claimed in claim 15, further comprising a conveying system to supply and discharge the supports, wherein stacked supports are discharged at substantially the same time as empty supports are supplied, wherein the entering empty supports follow the departing stacked supports.

35. The device as claimed in claim 15, further comprising a unit for supplying sheets.

36. The device as claimed in claim 15, further comprising buffer places for the objects in an operating area of said handling devices, said buffer providing temporary storage for the objects.

37. The method as claimed in claim 1, further comprising stabilizing the support after stacking.
